(19) United States
(12) Patent Application Publication
(10) Pub. No.: US 2007/0170851 A1
(43) Pub. Date: Jul. 26, 2007

(54) Functional device

(75) Inventor: Hiroyuki Yaegashi, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/653,841

(22) Filed: Jan. 17, 2007

(30) Foreign Application Priority Data
Jan. 20, 2006 (JP) 2006-012419

(51) Int. Cl. H01J 1/62; H01J 63/04

(52) U.S. Cl. 313/506

(57) ABSTRACT

A functional device with excellent manufacturability and excellent resistance to wire breakage failures is provided, and particularly improved organic and inorganic electroluminescent devices are provided.

The functional device includes a first electrode including a plurality of stripe electrodes disposed in parallel on a substrate, a second electrode disposed opposed to the first electrode, and a functional layer sandwiched between the electrodes, wherein a planarizing insulating layer is disposed at longitudinal direction edges of the stripe electrodes and fills the gaps between the stripe electrodes, and the functional layer is insulated from the first electrode at the longitudinal direction edges.

### CROSS REFERENCE TO RELATED APPLICATIONS

This application claims priority under 35USC 119 from Japanese Patent Application No. 2006-012419, the disclosure of which is incorporated herein by reference.

### BACKGROUND OF THE INVENTION

1. Field of the Invention

The invention relates to a functional device, and particularly relates to a functional device such as an organic electroluminescent device, an inorganic electroluminescent device, and a photoelectric conversion device.

2. Description of the Related Art

In recent years, various functional devices have been developed and suggested. For example, devices which emit light by applying electric current are known, such as organic and inorganic electroluminescent devices. On the other hand, photoelectric conversion devices which generate electricity by irradiating light are also known.

In particular, organic electroluminescent devices comprising a thin film material which is excited and emits light applying electric current emit high-intensity light at a low voltage. Therefore, organic electroluminescent devices have a wide range of potential applications in various fields including cellular phone displays, personal digital assistants (PDA), computer displays, automotive information displays, TV monitors, and general lighting. In these fields, organic electroluminescent devices have advantages such as slimming down, weight reduction, miniaturization, and power saving of the devices, and are thus greatly expected to play the leading role in the future electron display market. However, they have to achieve many technique improvements in order to replace conventional displays in these fields, for example, luminance and color tone, durability under a broad range of use environment conditions, and high-volume production capability at low costs.

Organic electroluminescent devices having a linear light source have been demanded. For example, linear organic electroluminescent devices using stripe electrodes are disclosed, such as a white light source for liquid crystal backlights and image sensors (e.g., Japanese Patent Application Laid-Open (JP-A) No. 2003-51380), and a light source for scanning exposure or image reading (e.g., JP-A No. 2005-260821). However, in the structure of the white light source, when the top electrode is thin, irregularities on the bottom electrode in stripes may cut the top electrode to cause a short. In the structure of the latter light source for scanning exposure or image reading, a lead wire is attached to all the stripe units to prevent shorts. This structure is preferable for linear light source having a small number of stripes, but in fine image reading, a lot of narrow stripes are required for exposure, it is thus difficult to attach a lead wire for retrieval to all the stripes.

### SUMMARY OF THE INVENTION

The present invention provides a functional device with excellent manufacturability and excellent resistance to wire breakage failures, and particularly to provide improved organic and inorganic electroluminescent devices.

The invention is a functional device comprising a substrate, a first electrode comprising a plurality of stripe electrodes disposed in parallel on the substrate, a second electrode disposed opposed to the first electrode, and a functional layer sandwiched between the electrodes, wherein a planarizing insulating layer is disposed at the edges in a longitudinal direction of the stripe electrodes and fills the gaps between the stripes, and the functional layer is insulated from the first electrode at the edges in a longitudinal direction.

### BRIEF DESCRIPTION OF THE DRAWINGS

FIG. 1 is a schematic diagram of the functional device in accordance with the embodiment of the invention;

FIG. 2 is a schematic diagram of the edges of the stripe electrodes of the functional device in accordance with the embodiment of the invention;

FIG. 3 is a schematic diagram of the edges of stripe electrodes of the functional device in accordance with a comparative embodiment.

### DESCRIPTION OF THE PREFERRED EMBODIMENTS

The functional device of the invention is a functional device comprising a first electrode comprising a plurality of stripe electrodes disposed in parallel on a substrate, a second electrode disposed opposed to the first electrode, and a functional layer sandwiched between the electrodes. It further comprises a planarizing insulating layer which is disposed at the edges of the stripes in a longitudinal direction of the first electrode, and fills the gaps between the stripes. “The edges in a longitudinal direction” are preferably portions overlapping the edges of the second electrode.

Preferably, the functional layer is insulated from the first electrode at the edges in a longitudinal direction. More preferably, the functional layer forms a continuous layer at the edges in a longitudinal direction. The term “continuous layer” refers to a layer in which the functional layer is integrally formed.

The planarizing insulating layer is preferably formed by a photosensitive resin or a thermosetting resin. Preferably, an inorganic insulating layer is disposed between the planarizing insulating layer and the functional layer.

Examples of the functional layer in the invention include: (1) a layer which emits light or creates distortion when a voltage or electric current is applied to it; (2) a layer which generates a voltage or electric current when visible light or X ray is irradiated, or a pressure is applied to it; and (3) a layer whose resistance value is changed by the change of atmosphere. Specific examples thereof include an organic electroluminescent light-emitting layer, an inorganic electroluminescent light-emitting layer, a photoelectric conversion layer, a piezoelectric layer, and a gas detecting layer. More preferable functional layers in the invention are an organic electroluminescent light-emitting layer, an inorganic electroluminescent light-emitting layer, and a photoelectric conversion layer.

1. Organic Electroluminescent Device

When the functional device of the invention is an organic electroluminescent device, the organic electroluminescent device may have, in addition to a emitting layer, a conventionally known organic compound layer such as a hole-transport layer, an electron-transport layer, a blocking layer, an electron injecting layer, and a hole injecting layer.

Hereinafter the invention is described in detail.

1) Layer Structure

<Electrode>

At least one of the pair of electrodes of the organic electroluminescent device is a transparent electrode, and the other is a back side electrode. The back side electrode may be transparent or opaque.

<Structure of Organic Compound Layer>

The layer structure of the organic compound layer is not particularly limited, and can be appropriately selected in accordance with the intended use and purpose of the organic electroluminescent device, but the layer is preferably formed on the transparent electrode or the back side electrode. In this case, the organic compound layer is formed on the front face or one face of the transparent electrode or the back side electrode.

The shape, size, and thickness of the organic compound layer are not particularly limited, and can be appropriately selected in accordance with the intended use.

Specific examples of the layer structure include followings, but the invention is not limited to these structures.

Anode/hole-transport layer/light-emitting layer/electron-transport layer/cathode,

Anode/hole-transport layer/light-emitting layer/blocking layer/electron-transport layer/cathode,

Anode/hole-transport layer/light-emitting layer/blocking layer/electron-transport layer/electron injecting layer/cathode,

Anode/hole injecting layer/hole-transport layer/light-emitting layer/blocking layer/electron-transport layer/cathode, and

Anode/hole injecting layer/hole-transport layer/light-emitting layer/blocking layer/electron-transport layer/electron injecting layer/cathode.

The respective layers are described below in detail.

2) Hole-Transport Layer

The hole-transport layer contains a hole transporting material. The hole transporting material can be used without no particular limitation as long as it has either a hole transporting function or a barrier function against electrons injected from the cathode. As the hole transporting material, either of a low-molecular hole transporting material and a polymer hole transporting material can be used.

Specific examples of the hole transporting material include following materials.

Conductive polymer oligomers such as carbazole derivatives, triazole derivatives, oxazole derivatives, oxadiazole derivatives, imidazole derivatives, polyaryl alkane derivatives, pyrazoline derivatives, pyrazolone derivatives, phenylenediamine derivatives, arylamine derivatives, amino-substituted chalcone derivatives, styryl anthracene derivatives, fluorenone derivatives, hydrazone derivatives, stilbene derivatives, silazane derivatives, aromatic tertiary amine compounds, styryl amine compounds, aromatic dimethylidene-based compounds, porphyrin-based compounds, polysilane-based compounds, poly(N-vinylcarbazole) derivatives, aniline-based copolymers, thiophene oligomers, and polythiophenes, and polymer compounds such as polythiophene derivatives, polyphenylene derivatives, polyphenylene vinylene derivatives, and polyfluorene derivatives.

These compounds may be used alone or in combination of two or more of them.

The thickness of the hole-transport layer is preferably 10 nm to 200 nm, and more preferably 20 nm to 80 nm. When the thickness exceeds 200 nm, the driving voltage may increase, and when less than 10 nm, the light-emitting device may cause a short. Therefore, the both cases are not preferable.

3) Hole Injecting Layer

In the invention, a hole injecting layer may be provided between the hole-transport layer and the anode.

The hole injecting layer is a layer for facilitating the injection of holes from the anode to the hole-transport layer. Specifically, among the hole transporting materials, those materials having a low ionizing potential are appropriately used. Preferable examples thereof include phthalocyanine compounds, porphyrin compounds, and starburst triarylamine compounds.

The film thickness of the hole injecting layer is preferably 1 nm to 30 nm.

4) Light-Emitting Layer

The light-emitting layer used in the invention comprises at least one light-emitting material, and if necessary, may contain a hole transporting material, an electron transporting material, and a host material.

The light-emitting material used in the invention is not particularly limited, and both of a fluorescent light-emitting material and a phosphorescent light-emitting material can be used. Of these, a phosphorescent light-emitting material is preferable in the point of light-emitting efficiency.

Examples of the fluorescent light-emitting material include various metal complexes such as a metal complex and a rare-earth complex of benzoxazole derivatives, benzoimidazole derivatives, benzothiazole derivatives, styrylbenzene derivatives, polyphenyl derivatives, diphenylbutadiene derivatives, tetraphenylbutadiene derivatives, naphthalimido derivatives, coumarin derivatives, perylene derivatives, perinone derivatives, oxadiazole derivatives, aldazine derivatives, pyraridine derivatives, cyclopentadiene derivatives, bisstyryl anthracene derivatives, quinacridone derivatives, pyrrolopyridine derivatives, thiadiazolo pyridine derivatives, styrylamine derivatives, aromatic dimethylidene compounds, and 8-quinolinol derivatives, and a polymer compound of polythiophene derivatives, polyphenylene derivatives, polyphenylenevinylene derivatives, and polyfluorene derivatives. These compounds may be used alone or in mixture of two or more of them.

The phosphorescent light-emitting material is not particularly limited, but an orthometallated metal complex or a porphyrin metal complex is preferable.

The term “orthometallated metal complex” is a generic name of the compound groups described, for example, in “Yuki Kinzoku Kagaku-Kiso to Oyo-” p. 150 to 232, written by Akio Yamamoto, and published by Shokabo Publishing Co., Ltd. (1982), and “Photochemistry and Photophisics of Coordination Compounds”, p. 71-77, p. 135 to 146, written by H. Yersin, edited by Springer-Verlag (1987). The use of the orthometallated metal complex as a light-emitting material in the light-emitting layer is advantageous in high intensity and excellent light-emitting efficiency.

The orthometallated metal complex comprises various ligands, such as those described in the above-mentioned reference. Among them, examples of preferable ligands include 2-phenylpyridine derivatives, 7,8-benzoquinoline derivatives, 2-(2-thienyl)pyridine derivatives, 2-(1-naphthyl)pyridine derivatives, and 2-phenylquinoline derivatives. If necessary, these derivatives may have a substituent. Furthermore, the orthometallated metal complex may have other ligand besides the ligands.

The orthometallated metal complex used in the invention can be synthesized by various known methods, such as those described in Inorg Chem., 1991, vol. 30, p. 1685, 1988, vol. 27, p. 3464, 1994, vol. 33, p. 545, Inorg. Chim. Acta, 1991, vol. 181, p. 245, J. Organomet. Chem., 1987, vol. 335, p. 293, and J. Am. Chem. Soc. 1985, vol. 107, p. 1431.

Among the orthometallated complexes, those compounds which emit light from triplet excited states can be preferably used from the viewpoint of improving light-emitting efficiency.

Among the porphyrin metal complexes, a porphyrin platinum complex is preferable.

Phosphorescent light-emitting materials may be used alone or in combination of two or more of them. Furthermore, a fluorescent light-emitting material and a phosphorescent light-emitting material may be used simultaneously.

The term “host material” refers to those materials which transfer energy from their excited state to a fluorescent or phosphorescent light-emitting material, and thereby cause light-emitting of the fluorescent or phosphorescent light-emitting material.

The host material is not particularly limited as long as it is a compound which can transfer exciter energy to alight-emitting material, and can be appropriately selected in accordance with the purpose. Specific examples thereof include metal complexes of carbazole derivatives, triazole derivatives, oxazole derivatives, oxadiazole derivatives, imidazole derivatives, polyaryl alkane derivatives, pyrazoline derivatives, pyrazolone derivatives, phenylene diamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene-based compounds, porphyrin-based compounds, anthraquinodimethane derivatives, anthrone derivatives, diphenylquinone derivatives, thiopyrandioxide derivatives, carbodiimide derivatives, fluorenylidenemethane derivatives, distyrylpyrazine derivatives, heterocycle tetracarboxyl acid anhydrides such as naphthalene perylene, phthalocyanine derivatives, and 8-quinolinol derivatives, various metal complexes of polysilane-based compounds such as those metal complexes having a ligand of metallophthalocyanine, benzoxazole, and benzothiazole, conductive polymer oligomers such as poly(N-vinylcarbazole) derivatives, aniline-based copolymers, thiophene oligomers, and polythiophene, and polymer compounds such as polythiophene derivatives, polyphenylene derivatives, polyphenylenevinylene derivatives, and polyfluorene derivatives. These compounds may be used alone or in combination of two or more of them.

The content of the host material in the light-emitting layer is preferably 0% by mass to 99.9% by mass, more preferably 0% by mass to 99.0% by mass.

5) Blocking Layer

In the invention, a blocking layer may be provided between the light-emitting layer and the electron-transport layer. The blocking layer is a layer which inhibits the diffusion of exciters generated in the light-emitting layer, and also inhibits holes from penetrating to the cathode side.

The material used for the blocking layer is not particularly limited as long as it is a material which can receive electrons from the transporting layer and feed them to the light-emitting layer, and may be a common electron transporting material. Examples of the material include metal complexes of triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, heterocycle tetracarboxylic acid anhydrides such as naphthalene perylene, phthalocyanine derivatives, 8-quinolinol derivatives, various metal complexes of polysilane-based compounds such as those metal complexes having a ligand of metallophthalocyanine, benzoxazole, and benzothiazole, conductive polymer oligomers such as aniline-based copolymers, thiophene oligomers, and polythiophene, and polymer compounds such as polythiophene derivatives, polyphenylene derivatives, polyphenylene vinylene derivatives, and polyfluorene derivatives. These compounds may be used alone or in combination of two or more of them.

6) Electron-Transport Layer

In the invention, an electron-transport layer containing an electron transporting material may be provided.

The electron transporting material is not particularly limited as long as it has either a hole transporting function or a barrier function against electrons injected from the cathode. The electron transporting materials as listed in the above description of the blocking layer can be appropriately used.

The thickness of the electron-transport layer is preferably 10 nm to 200 nm, and more preferably 20 nm to 80 nm.

When the thickness exceeds 200 nm, the driving voltage may increase, and when less than 10 nm, the electroluminescent device may cause shorts. Therefore, the both cases are not preferable.

7) Electron Injecting Layer

In the invention, an electron injecting layer may be provided between the electron-transport layer and the cathode.

The electron injecting layer is a layer for facilitating the injection of electrons from the cathode to the electron-transport layer. Specifically, preferable examples thereof include lithium salts such as lithium fluoride, lithium chloride, and lithium bromide, alkali metal salts such as sodium fluoride, sodium chloride, and cesium fluoride, and insulating metal oxides such as lithium oxide, aluminum oxide, indium oxide, and magnesium oxide.

The film thickness of the electron injecting layer is preferably 0.1 nm to 5 nm.

8) Organic Compound Layer Forming Method

The organic compound layer may be favorably formed by any of dry film-forming methods such as a vapor deposition method and a sputtering method, and a wet film-forming method such as a dipping method, a spin coating method, a dip coating method, a casting method, a die coating method, a roll coating method, a bar coating method and a gravure coating method. Among these methods, dry film-forming methods are preferable in the points of light-emitting efficiency and durability.

The next section describes the substrate and electrodes which are used when the invention is an organic electroluminescent device.

9) Substrate

As the material for the substrate, both for the first and second substrates, materials which do not permeate moisture or which have an extremely low moisture-permeating ratio are preferable, and materials which do not scatter or damp light emitted from the organic compound layers are preferably used. Specific examples thereof include inorganic materials such as zirconia-stabilized yttrium (YSZ) and glass, and organic materials such as synthetic resins, such as polyesters such as polyethylene terephthalate, polybutyrene terephthalate, and polyethylene naphthalate, polystyrene, polycarbonate, polyether sulfone, polyarylate, allyldiglycol carbonate, polyimide, polycycloolefin, norbornene resin, and poly(chlorotrifluoroethylene).

When the above-described organic materials are used, they are preferably superior in heat resistance, dimensional stability, solvent resistance, electrically insulating properties, workability, low permeability, and low hygroscopicity. Among these materials, when the transparent electrode is made of tin-doped indium oxide (ITO) which is favorably used as a material for the transparent electrode, a material which is slightly different from ITO in lattice constant is preferable. These materials may be used alone or in combination of two or more of them.

The shape, structure and size of substrate are not particularly limited, and can be appropriately selected in accordance with the intended use of the electroluminescent device. In general, the substrate is a plate shape. The structure may be either a single-layered structure and a laminate structure, and the substrate may be formed by a single member or by two or more members.

The substrate may be transparent and colorless, or transparent and colored but, in the point of not scattering or damping light emitted from the light-emitting layer, the substrate is preferably transparent and colorless.

It is preferable to provide a moisture-blocking layer (gas barrier layer) on the surface or backside (the transparent electrode side) of the substrate. As the material for the moisture-blocking layer (gas barrier layer), an inorganic material such as silicon nitride and silicon oxide is preferably used. The moisture-blocking layer (gas barrier layer) may be formed by, for example, a high frequency sputtering method.

If necessary, a hard coat or an undercoat may be provided on the substrate.

10) Anode

The anode usable in the invention suffices in usual cases as long as it functions as an anode for feeding holes to the organic compound layer. The anode is not particularly limited as to its shape, structure and size, and can be appropriately selected from known electrodes in accordance with the intended use and purpose of the electroluminescent device.

Examples of preferable materials for the anode include metals, alloys, metal oxides, organic conductive compounds and mixtures thereof, and these materials preferably have a work function of 4.0 eV or more. Specific examples thereof include semi-conductive metal oxides such as tin oxide doped with antimony or fluorine (ATO, FTO), tin oxide, zinc oxide, indium oxide, indium tin oxide (ITO), indium zinc oxide (IZO) such as ITO, metals such as gold, silver, chromium, and nickel, mixtures or laminates of the metals and the conductive metal oxides, inorganic conductive materials such as copper iodide and copper sulfide, organic conductive materials such as polyaniline, polythiophene and polypyrrole, and laminates of these materials and ITO.

The anode can be formed on the substrate by a method appropriately selected, taking into consideration adaptability with the above-mentioned materials, from among a wet method such as a printing method or a coating method, a physical method such as a vacuum vapor deposition method, a sputtering method or an ion plating method, and a chemical method such as a CVD method or a plasma CVD method. For example, in the case of selecting ITO as a material for the anode, the anode can be formed by a direct current or high frequency sputtering method, a vacuum vapor deposition method or an ion plating method. In the case of selecting an organic conductive compound as a material for the anode, the anode can be formed by a wet film-forming method.

The position of the anode in the electroluminescent device is not particularly limited, and can be appropriately selected in accordance with the intended use and purpose of the electroluminescent device. However, the anode is preferably formed on the substrate. In such case, the anode may be formed all over the one surface of the substrate or on part of the surface.

Patterning of the anode may be conducted by a chemical etching method such as photolithography, or a physical etching method such as laser etching. Furthermore, a vacuum vapor deposition method through a mask, a sputtering method, a lift-off method and a printing method are also applicable.

The thickness of the anode can be appropriately selected in accordance with the kind of the material and may not be specified in a general manner, but is usually 10 nm to 50 μm, and preferably 50 nm to 20 μm.

The resistance value of the anode is preferably 10³ Ω/□ or less, and more preferably 10² Ω/□ or less.

The anode may be transparent and colorless, or transparent and colored and, for taking out luminescence from the anode side, transparency of the anode is preferably 60% or more, and more preferably 70% or more. This transparency can be measured in a known manner using a spectrophotometer.

As to the anode, detailed descriptions are given in “Tomei Denkyokumaku-no-Sintenkai (New Development of Transparent Electrode Film)” supervised by Yutaka Sawada, and published by CMC Inc. (1999), and can be applied to the invention. In the case of using a plastic material having a low heat resistance as the substrate, the anode is preferably formed using ITO or IZO, and deposited at a temperature of 150° C. or lower.

11) Cathode

The cathode usable in the invention suffices in usual cases as long as it functions as a cathode for injecting electrons into the organic compound layer. The cathode is not particularly limited as to its shape, structure and size, and can be appropriately selected from known electrodes in accordance with the intended use and purpose of the electroluminescent device.

Examples of preferable materials for the cathode include metals, alloys, metal oxides, conductive compounds and mixtures thereof, and these materials preferably have a work function of 4.5 eV or more. Specific examples thereof include alkali metals (e.g., Li, Na, K, Cs), alkaline earth metals (e.g., Mg, Ca), and rare earth metals such as gold, silver, lead, aluminum, sodium-potassium alloy, lithium-aluminum alloy, magnesium-silver alloy, indium, and ytterbium. These materials may be used alone, or preferably in combination of two or more of them from the viewpoint of compatibility between stability and electron injecting properties.

Among these materials, alkali metals and alkaline earth metals are preferable in the point of electron injecting properties, and those materials which are made mainly of aluminum are preferable in the point of excellent storage stability. The materials made mainly of aluminum refer to aluminum alone, or alloys or mixtures of aluminum and 0.01% by mass to 10% by mass of an alkali metal or an alkaline earth metal (e.g., lithium-aluminum alloy, magnesium-aluminum alloy).

As to the materials for the cathode, detailed descriptions are given in JP-A Nos. 2-15595 and 5-121172. Both of them can be used in the invention.

The cathode is not particularly limited as to its forming method, and can be formed by a known method. For example, it can be formed on the substrate by a method appropriately selected, taking into consideration adaptability with the materials, from among a wet method such as a printing method and a coating method, a physical method such as a vacuum vapor deposition method, a sputtering method, and an ion plating method, and a chemical method such as a CVD method and a plasma CVD method. For example, in the case of selecting a metal or metals as a material for the cathode, the cathode can be formed by sputtering one, two or more kinds of them at the same time or successively.

Patterning of the cathode may be conducted by a chemical etching method such as photolithography, or a physical etching method such as laser etching. Furthermore, a vacuum vapor deposition method through a mask, a sputtering method, a lift-off method and a printing method are also applicable.

The position of the cathode in the organic electroluminescent device is not particularly limited, and can be appropriately selected in accordance with the intended use and purpose of the electroluminescent device. However, the cathode is preferably formed on the organic compound layer. In such case, the cathode may be formed all over the surface of the organic compound layer or on part of the surface.

Furthermore, a dielectric layer comprising a fluoride or the like of the alkali metal or the alkaline earth metal in the thickness of 0.1 nm to 5 nm may be inserted between the cathode and the organic compound layer.

The dielectric layer can be formed, for example, by a vacuum vapor deposition method, a sputtering method, or an ion plating method.

The thickness of the cathode can be appropriately selected in accordance with the materials and may not be specified in a general manner, but is usually 10 nm to 5 μm, and preferably 50 nm to 1 μm.

The cathode may be transparent or opaque. A transparent cathode can be formed by thinly depositing the cathode material with a thickness of 1 nm to 10 nm, and laminating a transparent conductive material such as ITO and IZO.

2. Inorganic Electroluminescent Device

When the functional device of the invention is an inorganic electroluminescent device, the inorganic electroluminescent device comprises first and second insulating films which are composed of an oxide having a high permittivity and disposed between electrodes, and a functional layer sandwiched between the insulating films, such as a light-emitting layer comprising a sulfide. As the material for the insulating layer, for example, tantalum pentoxide (Ta₂O₅), titanium oxide (TiO₂), yttrium oxide (Y₂O₃), barium titanate (BaTiO₃), and strontium titanate (SrTiO₃) can be used. As the material for the light-emitting layer, zinc sulfide (ZnS), calcium sulfide (CaS), strontium sulfide (SrS), barium thioaluminate (BaAl₂S₄) and the like can be used as the matrix of the light-emitting layer, and a material containing a trace amount of a transition metal element such as manganese (Mn), a rare earth element such as europium (Eu), cerium (Ce), and terbium (Tb) can be used as the light-emitting center.

3. Photoelectric Conversion Device

When the functional device of the invention is a photoelectric conversion device, the photoelectric conversion device comprises a functional layer such as a semiconductor layer with a pn junction or a pin junction between the electrodes or an X ray photoconductor layer which generates an electric charge when X ray is irradiated to it, and can be used for a light detector, a solar battery, an X ray detector and other applications. The material is selected from, in accordance with the intended use, for example, amorphous silicon (a-Si), polycrystalline silicon, amorphous selenium (a-Se), cadmium sulfide (CdS), cadmium telluride (CdTe), zinc oxide (ZnO), lead oxide (PbO), lead iodide (PbI₂), and Bi₁₂ (Ge, Si)O₂₀. If necessary, they may be doped with impurity to control the conduction type.

4. Piezoelectric-Crystal Device

When the functional device of the invention is a piezoelectric-crystal device, the piezoelectric-crystal device contains between the electrodes a functional layer such as a layer which creates distortion when a voltage is applied to it, or a layer which generates a voltage when a pressure or distortion is applied to it, and can be used, for example, for a pressure sensor, an acceleration sensor, an ultrasonic oscillator, and an actuator. As the material for a piezoelectric layer, for example, lead zirconate titanate (PZT), lead titanate (PbTiO₃), lithium niobate (LiNbO₃), lithium tantalate (LiTaO₃), lithium tetraborate (Li2B₄O₇), aluminum nitride (AlN), quartz (SiO₂), or polyvinylidene fluoride (PVDF) can be used.

The gas detecting layer contains between the electrodes, for example, a n type semiconductor layer whose resistance value changes in a gas. As the material for the n type semiconductor layer, for example, tin oxide (SnO₂) and zinc oxide (ZnO) can be used. A complex of porous silicon oxide (SiO₂) which supports metal nanoparticles such as Ag in its pores is also usable.

5. Device Structure

The structure of the device in the invention will be explained to the drawings.

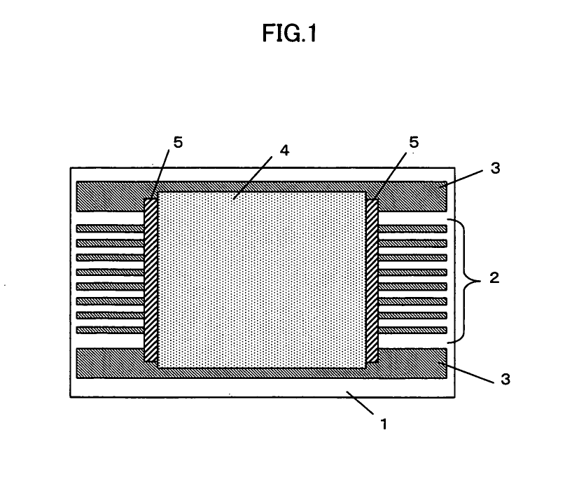

FIG. 1 is a schematic view of the functional device of the invention. The second electrode terminals are provided on edges (portions overlapping with edges of the second electrode) of the stripe-shaped first electrodes on the substrate. Stripe gaps at the edges of the stripe-shaped first electrodes are filled with the planarizing insulating layer. A functional layer is provided between the planar second electrode and the first electrodes.

On substrate 1, first electrodes 2 and second electrode terminals 3 are provided. These electrodes are preferably made of the same material. The material may be a transparent conductive film such as ITO, or an opaque metal electrode such as Al. On substrate 1 comprising these electrodes, planarizing insulating layer 5 is disposed in such a manner that it crosses first electrodes 2 at the edges in a longitudinal direction of the stripes of first electrodes 2. Planar second electrode 4 is disposed on the region sandwiched by planarizing insulating layer 5 disposed at the edges. Second electrode 4 and second electrode terminal 3 are directly and electrically connected. Furthermore, although not shown in the figure, a functional layer is provided between first electrodes 2 and planar second electrode 4 sandwiched by planarizing insulating layer 5 disposed at the longitudinal direction edges of the stripes.

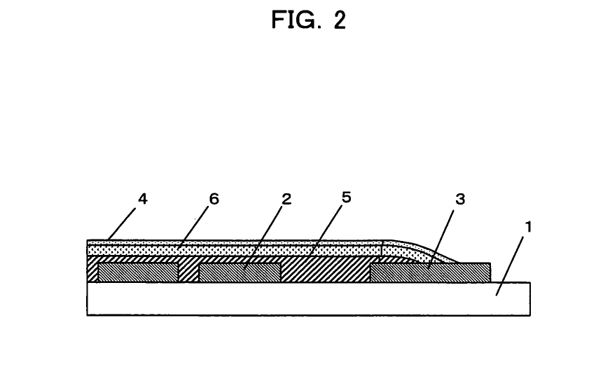

FIG. 2 is a schematic view of a section of the edge having a planarizing insulating layer of the functional device of the invention.

Planarizing insulating layer 5 is disposed on substrate 1 comprising first electrode 2 formed in stripes and second electrode terminal 3. Planarizing insulating layer 5 is formed in such a manner that it fills the gaps between first electrode 2 and second electrode terminal 3, and formed in such a manner that it partially covers first electrode 2 and second electrode terminal 3. Furthermore, functional layer 6 and second electrode 4 are successively formed.

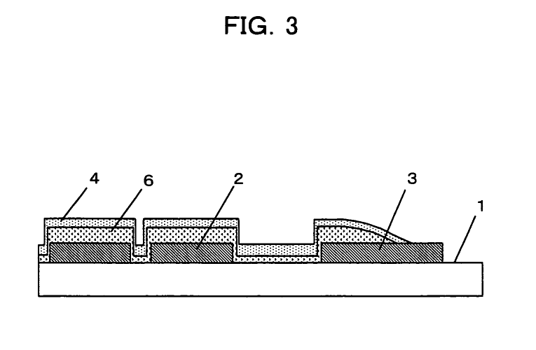

FIG. 3 is a schematic view of a section of the edge having no planarizing insulating layer, and a device structure for comparison.

Functional layer 6 and second electrode 4 are successively formed on substrate 1 comprising first electrode 2 formed in stripes and second electrode terminal 3. In this case, first electrode 2 and second electrode terminal 3, and the second electrode is not completely insulated at the step formed in the gap between first electrode 2 and second electrode terminal 3, which may cause shorts.

(Planarizing Insulating Layer)

<Function>

The planarizing insulating layer according to the invention is a layer which fills the steps in the gaps between the stripe electrodes to form a plane surface at which the upper surfaces of the electrodes and the upper surfaces of electrode-free portions are substantially coplanar, and allows the functional layer and the second electrode provided on the plane surface to form a planar layer. In other words, the planarizing insulating layer is a layer which fills the steps in the gaps between the plurality of the stripe electrodes so that the upper surface of the planarizing insulating layer forms a planer surface. As a result, the function of the functional layer is stabilized, and failure of the second electrode due to wire breakage is prevented.

It is preferable that the planarizing insulating layer not only fills the steps in the gaps between the stripe electrodes, but also forms an insulating layer between the stripe electrodes and the functional layer. For this reason, the thickness of the planarizing insulating layer is preferably larger than the thickness of the stripe electrodes. In other words, the thickness of the planarizing insulating layer formed in the gaps between the stripe electrodes is preferably larger than the height of the stripe electrodes.

<Material>

As the material used for the planarizing insulating layer, conventionally known materials which have been used as an insulating material can be used. Preferable materials are photosensitive resins or thermosetting resins. These materials are melted or dissolved in a solvent, filled, and cured by ultraviolet or visible light irradiation, or by heating to form a film with a high physical strength.

<Specific Examples of Photosensitive Resin or Thermosetting Resin>

As the photosensitive resin or thermosetting resin, an acrylic resin or an epoxy resin can be used without particular limitation. Of these, an epoxy resin is preferable in the point of moisture prevention.

<Forming Method>

The forming method of the planarizing insulating layer is not particularly limited, and examples thereof include a method of applying a resin followed by forming a predetermined pattern by photolithography, or a method of directly forming a predetermined pattern using a dispenser.

<Layer Thickness>

The thickness of the planarizing insulating layer is preferably larger than the thickness of the first electrode. If smaller, the first and second electrode may cause shorts at the pattern edges of the first electrode.

(Inorganic Insulating Layer)

The functional device of the invention may have an inorganic insulating layer between the planarizing insulating layer and the functional layer. The inorganic insulating layer is a layer which prevents deterioration due to intrusion of moisture or oxygen gas. As the material of the inorganic insulating layer, silicon nitride, silicon oxynitride, silicon oxide, and silicon carbide are preferably used.

The inorganic insulating layer can be formed by a CVD method, an ion plating method, a sputtering method, or a vacuum vapor deposition method.

The thickness of the inorganic insulating layer is preferably 0.01 μm to 10 μm. When less than 0.01 μm, it is not preferable because the insulation performance and moisture or gas prevention may be poor. When larger then 10 μm, it is not preferable from the viewpoint of processability because it may take too much time for film-forming. Furthermore, film stress may become excessive to cause the film to fall off. A thick film can be obtained by repeating a plural times of deposition.

(Resin Sealing Layer)

The resin sealing layer used in the invention is a layer which fills the vapor phase space between the inorganic film layer and the second substrate. Accordingly, the invention is remarkably characterized in that the gap between the inorganic film layer and the second substrate is thoroughly filled by a resin, and thus no vapor phase space is present.

<Material>

The resin material for the resin sealing layer is not particularly limited, and for example, acrylic resins, epoxy resins, fluorine-based resins, silicone-based resin, rubber-based resins, or ester-based resins can be used. Among them, epoxy resins are preferable in the point of moisture prevention function. Among epoxy resins, thermosetting epoxy resins, or light-curable epoxy resins are preferable.

<Forming Method>

The forming method of the resin sealing layer is not particularly limited, and examples of the method include a method of applying a resin solution, a method of bonding a resin sheet by compression or thermocompression, and a method of polymerizing by a dry method such as vapor deposition and sputtering.

<Film Thickness>

The thickness of the resin sealing layer is preferably 1 μm or more and 1 mm or less, more preferably 5 μm or more and 100 μm or less, and most preferably 10 μm or more and 50 μm or less. When the thickness is less than the above value, the inorganic film may be damaged when the second substrate is mounted. When the thickness is larger than the above value, the thickness of the electroluminescent device in itself becomes thick, which impairs the thin film characteristic of an organic electroluminescent device.

(Sealing Adhesive)

The organic electroluminescent device according to an embodiment of the invention is preferably sandwiched between two substrates, and the peripheral edges of the substrate is preferably sealed by a sealing adhesive having high moisture resistance. The sealing adhesive has a function of preventing moisture and oxygen from the edges.

The organic electroluminescent device is sandwiched between two substrates which are impermeable to moisture and gas, and has no vapor phase space in the sandwiched inside space, by which the intrusion of moisture and gas such as oxygen from outside is reduced extremely low. The intrusion can be prevented more completely by sealing the edges of the device with a sealing adhesive having high moisture resistance.

<Material>

As the material for the sealing adhesive, the same materials with those used for the resin sealing layer can be used. Among them, epoxy-based adhesives are preferable in the point of moisture prevention. Among them, light-curable epoxy-based adhesives are preferable.

Furthermore, it is also preferable to add a filler to the material.

As the filler added to the sealing agent, inorganic materials such as SiO₂, SiO (silicon oxide), SiON (silicon oxynitride), or SiN (silicon nitride) are preferable. Addition of a filler increases the viscosity, processability, and moisture resistance of the sealing agent.

<Drying Agent>

The sealing adhesive may contain a drying agent. As the drying agent, barium oxide, calcium oxide, or strontium oxide is preferable. The loading of the drying agent relative to the sealing adhesive is preferably 0.01% by mass or more and 20% by mass or less, and more preferably 0.05% by mass or more and 15% by mass or less. When the loading is less than the above value, the effect of adding the drying agent will be decreased. When the loading is higher than the above value, it is not preferable because uniform dispersion of the drying agent in the sealing adhesive becomes difficult.

<Formulation of Sealing Adhesive>

* Polymer Composition, Concentration

As the sealing adhesive, the above-mentioned materials can be used without no particular limitation. Examples of light-curable epoxy-based adhesives include XNR5516 (manufactured by Nagase chemteX Corporation). The above-mentioned drying agent can be directly added to and dispersed in the adhesive.

* Thickness

The application thickness of the sealing adhesive is preferably 1 μm or more and 1 mm or less. When the thickness is less than the above value, it is not preferable because the sealing adhesive cannot be uniformly applied. When the thickness exceeds the above value, it is also not preferable because the intrusion route of moisture becomes broad.

<Sealing Method>

In the invention, the functional device can be obtained by applying an arbitrary amount of the sealing adhesive containing a drying agent using a dispenser or the like, followed by overlaying the second substrate, and curing.

### EXAMPLES

The invention is described more specifically according to the following Examples. However the invention is by no means limited to them.

### Example 1

(Formation of Stripe Electrodes)

On an alkali-free substrate, a transparent conductive film, such as a lower electrode comprising ITO, was deposited with a film thickness of 200 nm by a sputtering method, and formed into stripes with widths of 50 μm at intervals of 50 μm by wet etching.

(Formation of Planarizing Insulating Layer)

Subsequently, photosensitive polyimide was applied on the entire surface by a spin coat method, and then an insulating layer having a width of 10 mm was formed by photolithography between the external connection terminals of the stripe-shaped lower electrodes and the functional region in such a manner that the layer was orthogonal to the stripe electrodes.

(Formation of Organic EL Layer)

Subsequently, an organic EL layer was deposited using a vapor deposition mask having an opening in a predetermined position. In this case, the organic EL layer was formed by successively vacuum depositing, for example, the following constituents at a thickness indicated inside the parentheses: a hole injecting layer (30 nm) comprising MTDATA [4,4′,4″-tris(3-methylphenylphenylamino)triphenylamine]; a hole-transport layer (20 nm) comprising α-NPD(N,N′-dinaphthyl-N,N′-diphenyl-[1,1′-biphenyl]4,4′-diamine); a light-emitting layer (30 nm) comprising a host of Alq3 (tris(8-hydroxyquinolinate) aluminum) doped with a light-emitting material of t(npa)py(1,3,6,8-tetra[N-(naphthyl)-N-phenylamino] pyrene; and an electron-transport layer (20 nm) comprising Alq3.

Subsequently, an upper electrode comprising Al was formed using an upper electrode vapor deposition mask having an opening in a predetermined position in such a manner that the upper electrode covered the organic EL layer, whereby a display device using an organic EL device of Example 1 of the invention was completed.

(Performance and Effect)

In the display device using the organic EL device of Example 1 of the invention, upon the application of a voltage to between the lower and upper electrodes, holes were injected from the lower electrode into the organic EL layer, and simultaneously electrons were injected from the upper electrode into the organic EL layer. The injected holes were transported to the light-emitting layer by the hole-transport layer. The injected electrons were transported to the light-emitting layer by the electron-transport layer.

The holes and electrons thus transported to the light-emitting layer were recombined together therein to emit light, and emitted light was extracted from the lower electrode side having translucency.

As described above, in Example 1 of the invention, although the upper electrode is provided in such a manner that it crosses the stripe-shaped lower electrodes, the insulating layer is provided between the external connection terminals of the stripe-shaped lower electrodes and the functional region and is planarized, and thus, even if the crossing upper electrode is severed in the functional region due to the thickness or shape of the stripe-shape lower electrodes, wire breakage can be prevented since connection of the upper electrode on the planarized insulating layer is maintained. Furthermore, since there is no polyimide, which is a resin, at the short side of the stripe electrodes in the functional region, light emission deterioration due to gas emitted from resin is greatly suppressed.

### Example 2

(Formation of Stripe Electrodes)

On an alkali-free glass substrate, a lower electrode comprising an ITO transparent conductive film was deposited by a sputtering method with a film thickness of 200 nm, and stripe electrodes were formed by wet etching with widths of 50 μm at intervals of 50 μm.

(Formation of Planarizing Insulating Layer)

Colloidal silica (trade name: PL-1, manufactured by Fuso Chemical Co. Ltd.) was applied to both the edges in a long side direction of the stripe electrodes with a width of 10 mm in such a manner that it is orthogonal to the stripe electrode, and dried. Subsequently, heating treatment was conducted at 500° C. for 1 hour to form a planarizing insulating layer.

(Formation of Inorganic EL Layer)

The first insulating film comprising tantalum pentoxide (Ta₂O₅) was formed with a film thickness of 200 nm in such a manner that the film partially covers the substrate, stripe electrodes, and planarizing insulating layer by sputtering at a substrate temperature of 200° C., a pressure inside the equipment of 1 Pa, a high frequency power of 1 kW, a sputtering rate of 0.2 nm/sec, and in an atmosphere of argon mixture gas containing oxygen. Subsequently, a light-emitting layer comprising zinc sulfide (ZnS) containing 3 mole % of manganese (Mn) was formed in the same manner with a film thickness of 400 nm by high frequency sputtering at a substrate temperature of 350° C. and in an atmosphere of argon mixture gas containing hydrogen sulfide (H₂S). Subsequently, a second insulating film comprising tantalum pentoxide (Ta₂O₅) was formed with a film thickness of 200 nm in the same manner as the first insulating layer.

After depositing the respective layers on the substrate, heat treatment was conducted at 400° C. for 1 hour in a vacuum of 10⁻⁴ Pa.

Furthermore, on the obtained surface, an electrode comprising aluminum was deposited by vacuum deposition with a film thickness of 50 nm, thus an inorganic EL device was prepared.

As described above, according to the invention, a functional device with excellent manufacturability and excellent resistance to wire breakage failures is provided. In particular, improved organic and inorganic electroluminescent devices are provided.

The foregoing description of the embodiments of the present invention has been provided for the purposes of illustration and description. It is not intended to be exhaustive or to limit the invention to the precise forms disclosed. Obviously, many modifications and variations will be apps rent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A functional device comprising a substrate, a first electrode comprising a plurality of stripe electrodes disposed in parallel on the substrate, a second electrode disposed opposed to the first electrode, and a functional layer sandwiched between the electrodes, wherein a planarizing insulating layer is disposed at longitudinal direction edges of the stripe electrodes and fills the gaps between the stripe electrodes, and the functional layer is insulated from the first electrode at the longitudinal direction edges.

2. The functional device of claim 1, wherein the longitudinal direction edges are portions overlapping the edges of the second electrode.

3. The functional device of claim 1, wherein the planarizing insulating layer fills the gaps between a plurality of the stripes, and the upper surface of the planarizing insulating layer is a layer which forms a flat surface.

4. The functional device of claim 1, wherein the functional layer forms a continuous layer at least at the longitudinal direction edges.

5. The functional device of claim 1, wherein the planarizing insulating layer comprises a photosensitive resin or a thermosetting resin.

6. The functional device of claim 5, wherein the photosensitive resin or thermosetting resin is an acrylic resin or an epoxy resin.

7. The functional device of claim 6, wherein the photosensitive resin or thermosetting resin is an epoxy resin.

8. The functional device of claim 1, wherein the thickness of the planarizing insulating layer formed in the gaps between a plurality of the stripe electrodes is larger than the height of the stripe electrodes.

9. The functional device of claim 1, wherein an inorganic insulating layer is provided between the planarizing insulating layer and the functional layer.

10. The functional device of claim 9, wherein the thickness of the inorganic insulating layer is 0.01 μm to 10 μm.

11. The functional device of claim 1, wherein at least one layer of the functional layer is a light-emitting layer.

12. The functional device of claim 11, wherein a light-emitting material contained in the light-emitting layer is a fluorescent light-emitting material or a phosphorescent light-emitting material.

13. The functional device of claim 1, wherein the functional device is an organic electroluminescent device.

14. The functional device of claim 1, wherein the functional device is an inorganic electroluminescent device.

15. The functional device of claim 1, wherein the functional device is a photoelectric conversion device.
